(19) United States
(12) Patent Application Publication
(10) Pub. No.: US 2007/0008590 A1
(43) Pub. Date: Jan. 11, 2007

(54) Image forming system, image forming apparatus and electronic mail transferring method thereof

(75) Inventor: Kang-hee Lim, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd.

(21) Appl. No.: 11/450,367

(22) Filed: Jun. 12, 2006

(30) Foreign Application Priority Data
Jul. 11, 2005 (KR) 2005-62136

(51) Int. Cl. G06F 3/12

(52) U.S. Cl. 358/402; 358/1.15

(57) ABSTRACT

An image forming system, an image forming apparatus and an electronic mail transferring method thereof. The electronic mail transferring method of the image forming apparatus completing an electronic mail including a predetermined image data, transmitting the completed electronic mail to a recipient's electronic mail address, and transmitting to the recipient's electronic mail address an electronic mail that failed to transmit due to the recipient's electronic mail address being at full capacity.

### CROSS-REFERENCE TO RELATED APPLICATIONS

This application claims priority under 35 U.S.C. § 119(a) of Korean PatentApplication No. 2005-62136, filed Jul. 11, 2005, in the Korean Intellectual Property Office, the entire contents of which are incorporated herein by reference.

### BACKGROUND OF THE INVENTION

1. Field of the Invention

The present general inventive concept relates to an image forming system, an image forming apparatus and an electronic mail transferring method thereof. More particularly, the present general inventive concept relates to an image forming system, an image forming apparatus and an electronic mail transferring method thereof repeatedly transferring the electronic mail until it is successfully transmitted in a cases where the electronic mail fails to reach its destination.

2. Description of the Related Art

With rapid expansion of Internet-related industries, Internet-related technologies and products have been developed and distributed. One such Internet-related product may be a network image forming apparatus. An image forming apparatus refers to an apparatus printing data on paper and forming the image, a duplicator, a facsimile, a printer or a multifunctional apparatus. The network image forming apparatus refers to an image apparatus having a network card mounted thereat, to transmit and receive data through a network.

Recently, the network image forming apparatus provides an electronic mail transmission function to complete an electronic mail including image data created by scanning a document to transmit to a recipient by Internet network instead of a public telephone network. This way, a user can transmit facsimile data in an electric mail form at far lower costs than using fees of a general facsimile.

FIG. 1 is a flowchart of a transmitting method of an electronic mail of a conventional image forming apparatus.

Referring to FIG. 1, an image forming apparatus receives an input containing an electronic mail address of a recipient and a maximum transferable size corresponding to a mail size the recipient may receive, and stores this input at a memory in S10.

When a transmission function of the electronic mail is selected in S20, the image forming apparatus completes the electronic mail including a scanned data created by scanning a document to transmit in S30. When the completed electronic mail does not exceed the maximum transferable size, the image forming apparatus immediately transmits the completed electronic mail to the recipient in S60, which is receivable at the recipient in S40-N.

When the completed electronic mail exceeds the maximum transferable size that may be received at the recipient in S40-Y, the image forming apparatus divides the electronic mail into the maximum transferable size or less that may be received in S50 and transmits the divided electronic mail to the recipient S60.

Likewise, the transmitting method of the electronic mail of the conventional image forming apparatus can prevent a mail server at the recipient from receiving the transmitted electronic mail exceeding the maximum transferable size which can be received by the recipient.

However, there is a still problem in that the recipient's mail server can not receive the electronic mail when the capacity of the recipient's mail storage box at the recipient's electronic mail address is full.

### SUMMARY OF THE INVENTION

The present general inventive concept provides an image forming apparatus and an electronic mail transferring method thereof capable of completing to transmit an electronic mail failing to have transmitted when a recipient mail server has failed to receive the electronic mail because a mail storage box corresponding to the electronic mail address of the recipient is full, or a capacity of the mail storage box is limited.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an electronic mail transferring method of an image forming apparatus, the method including completing an electronic mail including a predetermined image data, transmitting the completed electronic mail to the recipient's electronic mail address, and retransmitting to a recipient's electronic mail address the electronic mail that failed to transmitt because a mail storage box corresponding to the electronic mail address of the recipient was full.

The electronic mail that failed to transmit may be repeatedly transmitted in a preset cycle until it successfully reaches the recipient.

The completing of the electronic mail includes receiving the electronic mail address of the recipient, creating image data by scanning a document to be printed, and completing the electronic mail including the recipient's electronic mail address and the created image data.

The completing of the electronic mail may include determining whether the completed electronic mail exceeds a maximum transferable size, and dividing the completed electronic mail into a series of electronic mails that are the maximum transferable size or less when the completed electronic mail exceeds the maximum transferable size.

The electronic mail transferring method may further include indicating a message on transmission completion when the completed electronic mail is successfully transmitted.

The foregoing and/or other aspects and utilities of the present general inventive concept may also be achieved by providing an image forming apparatus including an electronic mail completing part that completes an electronic mail including predetermined image data, a communicating part to transmit the completed electronic mail to an electronic mail address of a recipient, a controlling part to control the communicating part to retransmit to the electronic mail address of the recipient the electronic mail which has failed to have transmitted in a mail storage box corresponding to the electronic mail address of the recipient was full.

The controlling part may control the communicating part to repeatedly transmit the electronic mail that failed to transmit in a preset cycle, until the electronic mail is successfully transmitted.

The image forming apparatus may further include an inputting part to input the electronic mail address of the recipient, and a scanning part to scan a document to print and to create an image data. The electronic mail completing part to complete the electronic mail including the received electronic mail address and the created image data.

The electronic mail completing part may determine whether the completed electronic mail exceeds a maximum transferable size, and divides the completed electronic mail into a plurality of emails, each having the maximum transferable size or less, when the completed electronic mail exceeds the maximum transferable size.

The image forming apparatus may further include an indicating part and the controlling part controls the indicating part to indicate a message on transmission completion when the completed electronic mail is completed to transmit.

The foregoing and/or other aspects and utilities of the present general inventive concept may also be achieved by providing an image forming system including an image forming apparatus to transmit an electronic mail including preset image data to a recipient's electronic mail address, and re-transmitting the electronic mail to an electronic mail address of the recipient when the transmitted electronic mail receives a message that the transmission failed in a case that the recipient's mail server including a mail storage box failed because to the mail storage box corresponding to the electronic mail address of the recipient is full, a mail server of a transmitter to transmit the electronic mail transmitted by the image forming apparatus to the mail server of the recipient, and to transfer the message on reception failures transmitted from the mail server of the recipient to the image forming apparatus, and the mail server of the recipient to store the transmitted electronic mail to the mail storage box, and to transmit the message on reception failures to the electronic mail address corresponding to the image forming apparatus having transmitted the electronic mail that failed to be received, in a case of failing to receive the transmitted electronic mail due to a limited capacity of the mail storage box.

The image forming apparatus may repeatedly transmit the electronic mail in a preset cycle, until the electronic mail that failed to be transmitted is successfully transmitted.

### BRIEF DESCRIPTION OF THE DRAWINGS

The above aspect and other features of the present invention will become more apparent by describing in detail exemplary embodiments thereof with reference to the attached drawing figures, wherein;

FIG. 1 is a flowchart of a transmitting method of an electronic mail of a conventional image forming apparatus;

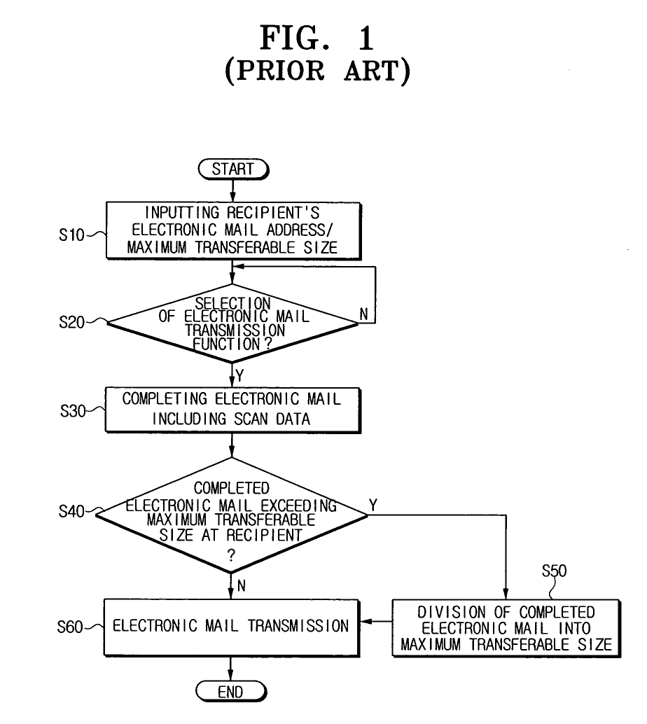

FIG. 2 is a block diagram illustrating an image forming system according to an embodiment of the present general inventive concept;

FIG. 3 is a block diagram illustrating the image forming system of FIG. 2;

FIG. 4 is a flowchart illustrating a transmitting method of an electronic mail of an image forming apparatus according to an embodiment of the present general inventive concept; and

FIG. 5 is a flowchart illustrating an operation S410 of the method of FIG. 4.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

In the following description, the same drawing reference numerals are used for the same elements, even in different drawings. The matters defined in the description such as a detailed construction and elements are nothing but the ones provided to assist in a comprehensive understanding of the invention. Thus, it is apparent that the present general inventive concept can be carried out without those defined matters. Also, well-known functions or constructions are not described in detail since they would obscure the general inventive concept in unnecessary detail.

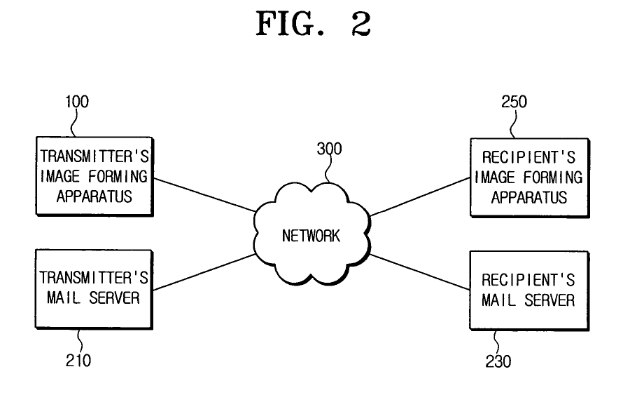

FIG. 2 is a block diagram illustrating an image forming system according to an embodiment of the present general inventive concept. Referring to FIG. 2, the image forming system includes a transmitter's image forming apparatus 100, a transmitter's mail server 210, a recipient's mail server 230, and a recipient's image forming apparatus 250, and is communicably connected through a network 300. The network 300 may be formed by a sharing device such as a LAN or HUB, and Internet network.

The transmitter's mail server 210 transmits an electronic mail including image data transmitted from the transmitter's image forming apparatus 100, to the recipient's mail server 230 corresponding to an electronic mail address of a recipient. The mail server of a transmitter 210 receives a message on a reception success corresponding to successfully receiving the electronic mail from the recipient's mail server 230, or a message on a reception failure corresponding to failing to receive the electronic mail, and transmits the message to the transmitter's image forming apparatus 100.

The mail server of the transmitter mail server 210 supports an SMTP (Simple Mail Transfer Protocol) and POP3 (Post Office Protocol 3) when the transmitter's image forming apparatus 100 transmits and receives the electronic mail. The SMTP supervises transmitting the electronic mail, while POP3 supervises receiving the electronic mail.

In order to transmit the electronic mail including the image data, the transmitter's image forming apparatus 100 transmits to the recipient's mail server 230 where the electronic mail address of the recipient belongs, through the transmitter's mail server 210 using the SMTR In particular, the transmitter's image forming apparatus 100 according to the present general inventive concept re-transmits the corresponding electronic mail in a predetermined cycle until receiving a message on successful reception of the electronic mail, in a case of receiving the message on the reception failure of the electronic mail.

The recipient's mail server 230 supports the SMTP (Simple Mail Transfer Protocol) and POP3 (Post Office Protocol 3) when the recipient's image forming apparatus 250 transmits and receives the electronic mail. The recipient's mail server 230 has a mail storage box to store the electronic mail transmitted to the electronic mail address (hereinafter, referred to as an electronic mail address of a recipient) corresponding to the recipient's image forming apparatus 250.

When the transmitted electronic mail is normally stored at the mail storage box, the recipient's mail server 230 transmits the message on the reception success to the transmitter's mail server 210, while transmitting the message on the reception failure to the transmitter's mail server 210 when failing to receive the transmitted electronic mail. In particular, in a case of failing to receive the electronic mail due to a limited capacity of the mail storage box corresponding to the electronic mail address of the recipient, the recipient's mail server 230 transmits the message including corresponding details to the transmitter's mail server 210. When the electronic mail including the image data is externally transmitted and stored at the recipient's mail server 230, the recipient's image forming apparatus 250 reads the electronic mail in a predetermined cycle using the POP3 and prints the image data included in the electronic mail.

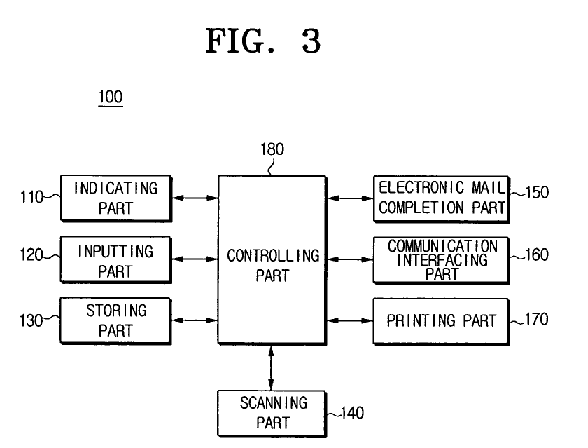

Hereinafter, the transmitter's mail server 210 of FIG. 2 will be described in detail with reference to FIG. 3.

Referring to FIGS. 2 and 3, the transmitter's image forming apparatus 100 according to an embodiment of the present general inventive concept includes an indicating part 110, an inputting part 120, a storing part 130, a scanning part 140, an electronic mail completion part 150, a communication interfacing part 160, a printing part 170, and a controlling part 180.

The indicating part 110 may be employed with an LCD panel and indicates one or more menus selectable of information on an operation state of the transmitter's image forming apparatus 100 and various functions supported by the transmitter's image forming apparatus 100, under control of the controlling part 180. In particular, the indicating part 110 according to the present embodiment indicates a message on transmission completion according to control of the controlling part 180 when the electronic mail is successfully transmitted.

The inputting part 120 inputs one or more commands to set or to select various functions supported by the transmitter's image forming apparatus 100 from a user, and may have a plurality of input buttons and touch screens through which the user inputs the one or more commands.

The inputting part 120 inputs a recipient's electronic mail address and a maximum transferable size of an electronic mail and which are stored at the storing part 130. The maximum transferable size of the electronic mail refers to a maximum size of the electronic mail which is receivable at a transmitter's mail server 210 or a recipient's mail server 230, and may be preset by a user.

The storing part 130 stores various control programs and data necessary for performing functions of the transmitter's image forming apparatus 100. The storing part 130 stores the image data created by scanning a document to transmit and the electronic mail completed by the electronic mail completion part 150.

The scanning part 140 scans the document to transmit and creates the image data.

The electronic mail completion part 150 completes the electronic mail to externally transmit through the communication interfacing part 160. In particular, the electronic mail completion part 150 according to the present embodiment completes the electronic mail including the image data created by scanning the document at the scanning part 140 and the electronic mail address of the recipient input through the inputting part 120. The electronic mail completion part 150 divides the completed electronic mail into a plurality of electronic mails each having the maximum transferable size or less, in a case that a size of the completed electronic mail is larger than the maximum transferable size.

The communication interfacing part 160 is connected to the network 300 and performs communications between a predetermined external image forming apparatus and a mail server. In particular, the communication interfacing part 160 may transmit and receive the electronic mail through the mail server supporting the SMTP and POP3 on the network 300. The communication interfacing part 160 may transmit and receive fax data to and from an external facsimile.

The printing part 170 may print the image data created by scanning the document at the scanning part 140 according to the control of the controlling part 180. The printing part 170 may print the image data included in the electronic mail transmitted from the external image forming apparatus or fax data.

The controlling part 180 controls an overall operation of the transmitter's image forming apparatus 100. In particular, the controlling part 180 according to the present embodiment repeatedly transmits the corresponding electronic mail in a predetermined cycle, when the electronic mail has failed to be transmitted to the electronic mail address of the recipient. A message on the reception success or failure transmitted from the recipient's mail server 230 informs the user whether the transmitted message is successfully received or not. The message on the reception failure includes why the recipient's mail server 230 has failed to receive the electronic mail.

The reception failure of electronic mail may be one of two cases including the recipient's setting to reject the electronic mail received from the transmitter, and the limited capacity of a mail storage box corresponding to the recipient's electronic mail address. In the first case, where the recipient is set to reject the electronic mail received from the transmitter, it is useless to re-transmit the electronic mail, and accordingly the user may finish the transmission work and indicate a message on transmission failure on the indicating part 110.

In the second case where the mail storage box of the recipient is full, the electronic mail stored at the mail storage box may be deleted such that the electronic mail can reach the recipient's mail server 230. Accordingly, the controlling part 180 controls the communication interfacing part 160 to repeatedly transmit the electronic mail in a predetermined cycle in a case of the reception failure of the electronic mail by the recipient's mail server 230 due to the full capacity of the mail storage box. The controlling part 180 indicates the message on transmission completion on the indicating part 110 when the electronic mail is successfully completed.

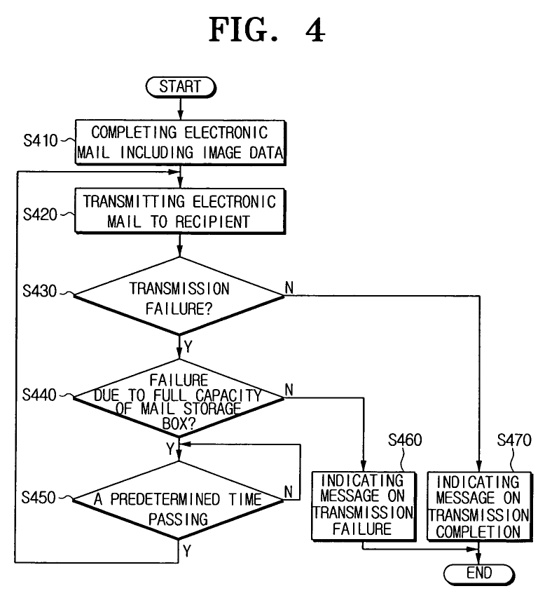

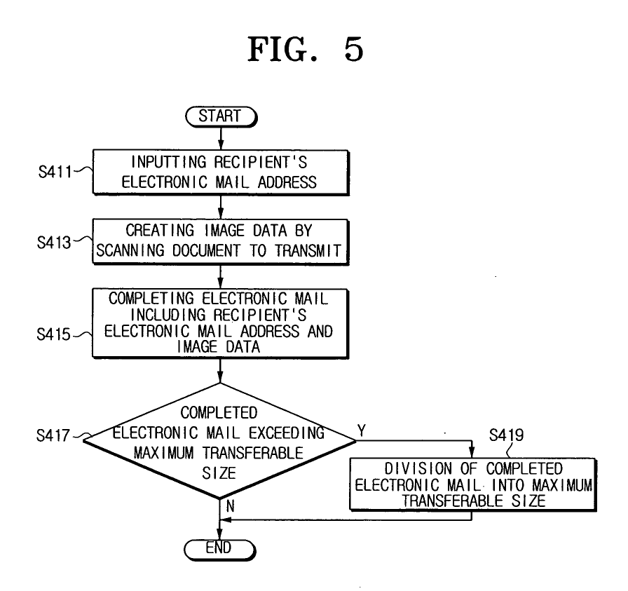

FIG. 4 is a flowchart illustrating a transmitting method of an electronic mail of an image forming apparatus according to the embodiment of the present general inventive concept, and FIG. 5 is a flowchart illustrating an operation S410 of the method of FIG. 4.

Referring to FIGS. 2, 3, 4, and 5, the electronic mail completion part 150 completes the electronic mail including the image data S410. The completing of the electronic mail in operation S410 may include the following operations.

The inputting part 120 inputs the electronic mail address of the recipient from the user in operation S411. The scanning part 140 creates the image data by scanning the document to transmit in operation S413. The electronic mail completion part 150 completes the electronic mail including the electronic mail address of the recipient and the image data in S415. According to the present embodiment, the image data created by scanning the document to transmit is included in the electronic mail. However, various changes in form and details may be made therein without departing from the spirit and scope of the general inventive concept. The image data transmitted from the external device or the preset image data selected by the user may be included in the electronic mail.

The controlling part 180 determines whether a size of the completed electronic mail exceeds the maximum transferable size or not in operation S417. When the mail size exceeds the transferable maximum size, the controlling part 180 divides the completed electronic mail into a plurality of electronic mails each having the maximum transferable size or less in operation S419. Depending on an embodiment of the present general inventive concept, operations S417 and S419 may be omitted.

The controlling part 180 transmits the completed mail to the recipient's mail server 230 where the electronic mail address of the recipient belongs, through the recipient's mail server 230 using the SMTP in operation S420.

The controlling part 180 receives the message on the reception success or failure of the electronic mail transmitted from the recipient's mail server 230, through the transmitter's mail server 210, and determines whether the electronic mail is transmitted or not in operation S430.

The controlling part 180 determines that the transmission is successful when the transmitter's mail server 210 receives the message on reception success in operation S430-N, which indicates the message on transmission completion on the indicating part 110 in operation S470 and finishes the transmission.

When the transmission of the electronic mail fails in operation S430-Y, the controlling part 180 determines whether the reception failure is due to the full capacity of the mail storage box of the recipient or a situation in which the mail storage box is full in operation S440. If the failure is not by the full capacity of the mail storage box in S440-N, the controlling box 180 indicates the message on the reception failure on the indicating part 110in operation S460, and finishes the transmission of the electronic mail.

If the reception failure is due to the limited capacity of the mail storage box in operation S440-Y, the controlling part 180 proceeds into operation S420 after a predetermined time in operation S450-Y, and controls the communication interfacing part 160 to transmit the electronic mail failing to have transmitted to the recipient's mail server 230 where the electronic mail address of the recipient belongs. The controlling part 180 repeats operation S420 or S450 until the electronic mail failing to have transmitted is successfully transmitted.

For the convenience of explanation, the general inventive concept is described separately for the transmitter having the image forming apparatus and the mail server, and the recipient having the image forming apparatus and the mail server. However, when the recipient's image forming apparatus 230 transmits the electronic mail to the transmitter's image forming apparatus 210, the recipient may play a role of the transmitter, while the transmitter performs the role of the recipient.

As above mentioned, according to the embodiment of the present general inventive concept, when the transmission failure takes place due to a limited mail receiving capacity of the mail storage box to receive the electronic mail at the recipient's electronic mail address, the electronic mail failing to have transmitted may be successfully transmitted.

Accordingly, the user is not required to additionally operate the image forming apparatus, in order to re-transmit the electronic mail that failed to transmit due to the limited capacity of the mail storage box, so that the user can enjoy enhanced conveniences.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electronic mail transferring method of an image forming apparatus, the method comprising:
completing an electronic mail including predetermined image data;
transmitting the completed electronic mail to a recipient's electronic mail address; and
retransmitting to the recipient's electronic mail address the electronic mail that failed to transmit due to a limited capacity of a mail storage box of corresponding to the recipient's electronic mail address.

2. The electronic mail transferring method of claim 1, wherein the electronic mail that failed to transmit is repeatedly transmitted in a preset cycle until successfully reaching the recipient.

3. The method of transferring electronic mail of claim 1, wherein the completing of the electronic mail further comprises:
receiving the electronic mail address of the recipient;
creating the image data by scanning a document to be printed; and
completing the electronic mail including the received electronic mail address and the created image data.

4. The electronic mail transferring method of claim 3, wherein the completing of the electronic mail further comprises:
determining whether a size of the completed electronic mail exceeds a maximum transferable size; and
dividing the completed electronic mail into a plurality of sub-mails each having the maximum transferable size or less when the completed electronic mail exceeds the maximum transferable size.

5. The electronic mail transferring method of claim 1, further comprising:
indicating a message on transmission completion when the completed electronic mail is successfully transmitted.

6. An image forming apparatus comprising:
an electronic mail completion part to complete an electronic mail including a predetermined image data;
a communicating part to transmit the completed electronic mail to an electronic mail address of an recipient; and
a controlling part to control the communicating part to retransmit to the electronic mail address of the recipient an electronic mail that failed to transmit due to a limited capacity of a mail storage box corresponding to the electronic mail address of the recipient.

7. The image forming apparatus of claim 6, wherein the controlling part controls the communicating part to repeatedly transmit the electronic mail failing to have transmitted in a preset cycle, until the electronic mail that failed to transmit is successfully transmitted.

8. The image forming apparatus of claim 6, further comprises:
an inputting part to input the electronic mail address of the recipient; and
a scanning part to scan a document to create image data,
wherein the electronic mail completion part completes the electronic mail including the received electronic mail address and the created image data.

9. The image forming apparatus of claim 8, wherein the electronic mail completion part determines whether a size of the completed electronic mail exceeds a maximum transferable size, and then divides the completed electronic mail into a plurality of sub-mails, each having the maximum transferable size or less, when the size of the completed electronic mail exceeds the maximum transferable size.

10. The image forming apparatus of claim 9 further comprising:
an indicating part to indicate a message on the completion of transmission when the electronic mail transmission is complete.

11. An image forming system comprising:
an image forming apparatus to transmit an electronic mail including a predetermined image data to a recipient's electronic mail address, and re-transmitting the electronic mail to the electronic mail address of the recipient when receiving a message on reception failure in a case that the recipient's mail server, including a mail storage box, failed to receive the electronic mail due to the recipient's electronic mail address being at full capacity;
a mail server of a transmitter to transmit the electronic mail transmitted by the image forming apparatus to the mail server of the recipient, and to transfer a message on the reception failure transmitted from the mail server of the recipient to the image forming apparatus; and
the recipient 's mail server to store the transmitted electronic mail to the mail storage box, and to transmit the message on the reception failure to an electronic mail address corresponding to the image forming apparatus that transmitted the failed electronic mail,

12. The image forming system of claim 11, wherein the image forming apparatus repeatedly transmits the electronic mail in a preset cycle, until the electronic mail that failed to transmit is successfully transmitted.

13. An image forming apparatus comprising:
a communicating part to transmit an electronic mail to an external device; and
a controlling part to receive a signal corresponding to the transmitted electronic mail and representing a failure of the transmitted electron mail, and to control the communicating part to retransmit the electronic mail to the external device.

14. The image forming apparatus of claim 13, further comprising:
a scanning part to scan an image to generate image data;
an electronic mail completion part to complete the electronic mail, including the image data; and
a printing part to print the image data on a printing medium.

15. The image forming apparatus of claim 13, further comprising:
an inputting part to input image data and an electronic mail address corresponding to the external device; and
an electronic mail completion part to complete the electronic mail including the image data and the electronic mail address.

16. The image forming apparatus of claim 13, further comprising:
a sharing device connected to the communicating part such that the communicating part communicates with the external device, wherein the sharing device comprises one of a wire or wireless network and Internet.

17. The image forming apparatus of claim 13, wherein the external device comprises a mail server connected to the communicating part through a network or Internet to receive the electronic mail.

18. The image forming apparatus of claim 13, wherein the external device comprises an electronic mail box having a limited capacity to receive an external electronic mail, and outputs the signal when the electronic mail box fails to receive the electronic mail due to the limited capacity.

19. The image forming apparatus of claim 13, wherein the controlling part divides the electronic mail into one or more sub-mails having a transferable size according to the signal.

20. The image forming apparatus of claim 13, wherein the controlling part controls the communicating part not to retransmit the electronic mail when receiving a second signal representing a success of the retransmitted electronic mail.
